(19) United States
(12) Patent Application Publication
(10) Pub. No.: US 2021/0277972 A1
(43) Pub. Date: Sep. 9, 2021

(54) FRICTION MATERIAL

(71) Applicant: BorgWarner Inc., Auburn Hills, MI (US)

(72) Inventors: Richard W. Pridgen, Jr., Arlington Heights, IL (US); Benjamin A. Siegel, Chicago, IL (US); Steven J. Kowal, Naperville, IL (US); David T. Vierk, Mokena, IL (US)

(21) Appl. No.: 17/126,773

(22) Filed: Dec. 18, 2020

Related U.S. Application Data
(60) Provisional application No. 62/984,984, filed on Mar. 4, 2020.

(51) Int. Cl. F16D 69/02; F16D 13/64; F16D 69/04

(52) U.S. Cl. CPC F16D 69/026; F16D 13/64; F16D 2069/008; F16D 2200/0069; F16D 2069/0466; F16D 69/04

(57) ABSTRACT

A friction material includes a friction-generating layer and a base layer. The base layer includes base fibers and presents a bonding surface. The friction-generating layer includes friction-adjusting particles deposited on the base layer and presents a friction-generating surface facing opposite the bonding surface of the base layer. A curable resin is present in the friction-generating layer and the base layer. The friction material also includes a composition including a plurality of triglycerides. The composition is present in at least one of the friction-generating layer and the base layer. The plurality of triglycerides comprises polyunsaturated fatty acid in a content of from 60 to 90% by weight based on a total weight of the plurality of triglycerides included in the composition.

### CROSS-REFERENCE TO RELATED APPLICATION

The present United States Non-Provisional Patent Application claims priority to and all the benefits of U.S. Provisional Patent Application No. 62/984,984 filed on Mar. 4, 2020, which is hereby expressly incorporated herein by reference in its entirety

### FIELD OF THE DISCLOSURE

This disclosure generally relates to a friction material that may be used in a variety of different applications including in a friction plate in a clutch assembly in a transmission.

### BACKGROUND

Several components of a powertrain of a motor vehicle may employ a wet clutch to facilitate the transfer of power from the vehicle's power generator (e.g. an internal combustion engine, electric motor, fuel cell, etc.) to drive wheels of the motor vehicle. A transmission located downstream from the power generator that enables vehicle launch, gear shifting, and other torque transfer events is one such component. Some form of a wet clutch is commonly found throughout many different types of transmissions currently available for motor vehicle operation.

A wet clutch is an assembly that interlocks two or more opposed, rotating surfaces in the presence of a lubricant by imposing selective interfacial frictional engagement between those surfaces. At the point of engagement, a friction material is utilized to generate the interfacial frictional engagement. The friction material is supported by a friction clutch plate, a band, a synchronizer ring, or some other part. The presence of the lubricant at the friction interface cools and reduces wear of the friction material and permits some initial slip to occur so that torque transfer proceeds gradually, although very quickly, in an effort to avoid the discomfort that may accompany an abrupt torque transfer event (i.e., shift shock).

Friction materials used in the variety of wet clutches found in motor vehicle powertrains must be able to withstand repeated forces and elevated temperatures that are typically generated during the repeated engagement and disengagement of transmissions. During use, the friction material must be able to maintain a relatively constant friction throughout engagement, maintain cohesive integrity, and, where applicable, maintain adhesion to the substrate for thousands of engagements and disengagements of such transmissions.

In view of the above, there remains an opportunity to develop a friction material with improved performance properties in a wide variety of different wet clutch applications.

### SUMMARY OF THE DISCLOSURE

A friction material including a friction-generating layer and a base layer is disclosed. The base layer includes base fibers and presents a bonding surface. The friction-generating layer includes friction-adjusting particles deposited on the base layer and presents a friction-generating surface facing opposite the bonding surface of the base layer. A curable resin is present in the friction-generating layer and the base layer. The friction material also includes a composition including a plurality of triglycerides. The composition is present in at least one of the friction-generating layer and the base layer. The plurality of triglycerides comprises polyunsaturated fatty acid in a content of from 60 to 90% by weight based on a total weight of the plurality of triglycerides included in the composition.

Advantageously, this friction material, with the composition including the plurality of triglycerides, generates friction and withstands forces and elevated temperatures that are typically generated during the repeated engagement and disengagement of transmissions. Further, the friction-generating layer and the base layer exhibit excellent cohesion and strength. To this end, the friction material may be used in a wide variety of wet clutch applications and performs optimally across this wide variety of wet clutch applications.

### BRIEF DESCRIPTION OF THE FIGURES

Other advantages of the present disclosure will be readily appreciated, as the same becomes better understood by reference to the following detailed description when considered in connection with the accompanying drawings.

FIG. 1 is a cross-sectional view of one embodiment of a friction material including a friction-generating layer and a base layer.

FIG. 2 is a cross-sectional view of a friction plate including the friction material of FIG. 1.

FIG. 3 is a perspective view of a clutch assembly including a plurality of friction and separator plates in a transmission.

It should be appreciated that the drawings are illustrative in nature and are not necessarily drawn to scale.

### DETAILED DESCRIPTION OF THE DISCLOSURE

Referring to the Figures, wherein like numerals indicate corresponding parts throughout the several views, a friction material is shown generally at 10. The friction material 10 includes a friction-generating layer 12 and a base layer 14. The friction-generating layer 12 presents a friction-generating surface 18, and the base layer 14 presents a bonding surface 20 facing opposite the friction-generating surface 18 of the friction-generating layer 12.

In some embodiments, the friction material 10 has a thickness T₁ defined as the distance between the friction-generating surface 18 and the bonding surface 20 and in many such embodiments, the friction-generating layer 12 extends from the friction-generating surface 18 towards the bonding surface 20 up to 10, 20, 30, or 40% of the thickness T₁, and the base layer 14 extends from the bonding surface 20 towards the friction-generating surface 18 up to 10, 20, 30, 40, 50, 60, or 70% of the thickness T₁.

It should be appreciated that include, includes, and including are the same as comprise, comprises, and comprising when used throughout this disclosure.

### The Friction Material

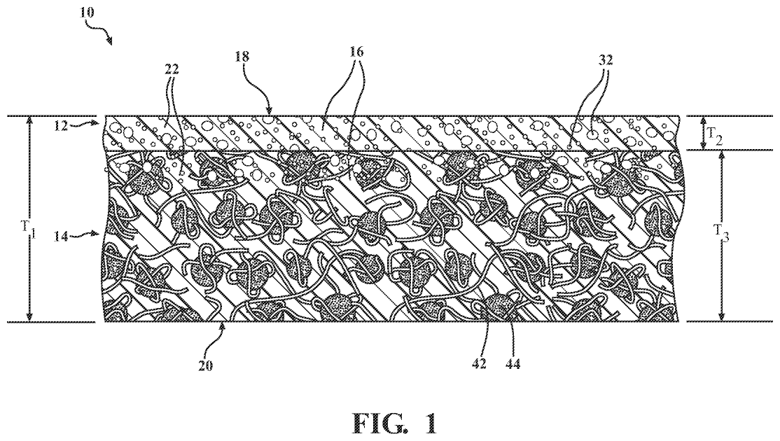

FIG. 1 is a cross-sectional view of one example of the friction material 10 including the friction-generating layer 12 and the base layer 14. The friction material 10 is porous with a resin 16 and a composition 22 present therein. Each of the friction-generating layer 12, the base layer 14, the resin 16, and the composition 22 is described in greater detail below.

### The Base Layer

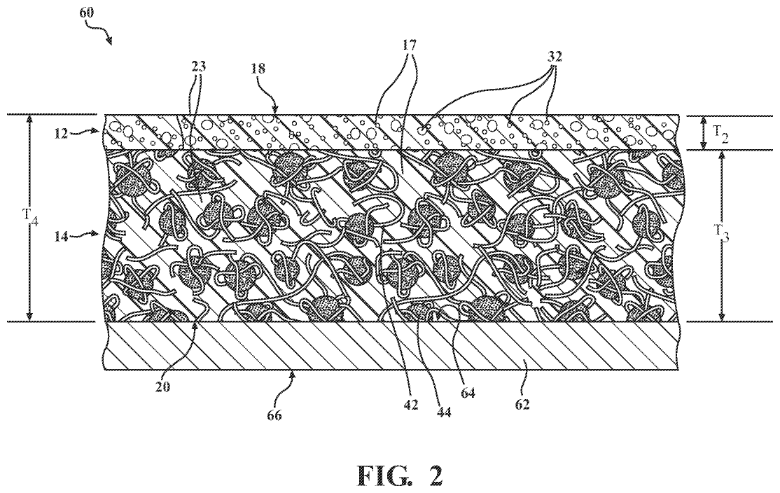

As shown in FIGS. 1 and 2, the friction material 10 includes the base layer 14. The base layer 14 may be alternatively described as a paper layer, a primary layer or as a porous layer. The base layer 14 may also be described as paper or raw paper. In some embodiments, the base layer 14 has a thickness T₃ of from 0.2 mm to 3.75 mm, from 0.3 mm to 3 mm, from 0.3 mm to 2.1 mm, from 0.3 mm to 2 mm, 0.4 mm to 1.9 mm, from 0.3 mm to 1 mm, from 0.3 mm to 0.9 mm, from 0.1 mm to 0.9 mm, from 0.4 mm to 0.8 mm, from 0.5 mm to 0.7 mm, from 0.6 mm to 0.7 mm, or from 0.2 mm to 0.35 mm. Alternatively, the thickness T₃ of the base layer 14 is less than 3.75 mm, less than 3 mm, less than 2 mm, less than 1 mm, less than 0.9 mm, less than 0.8 mm, less than 0.7 mm, less than 0.6 mm, less than 0.5 mm, or less than 0.4 mm, but greater than 0.1 mm. In additional non-limiting embodiments, all thickness T₃ values and ranges of values within and including the aforementioned range endpoints are hereby expressly contemplated. This thickness T₃ may refer to a thickness prior to, or after, resin 16 cure.

In some embodiments, the base layer 14 is discrete and well defined relative to edges and/or demarcation. In other embodiments, the base layer 14 is not discrete and well defined relative to edges and/or demarcation. In such embodiments, the base layer 14 is indiscrete and may blend or penetrate into the friction-generating layer 12 to varying degrees, as described in greater detail below. For example, the base layer 14 may blend into the friction-generating layer 12 in a gradient type of pattern.

The base layer 14 includes base fibers 42. The base fibers 42 may be alternatively described as a plurality of fibers. The base fibers 42 may include one or more different types of fibers. The base fibers 42 are typically present in an amount of from 20 to 100 or from 20 to 80, % by weight based on a total weight of all non-resin and non-composition components the base layer 14. In various embodiments, the base fibers 42 are present in an amount of from 25 to 75, 30 to 70, 35 to 65, 40 to 60, 45 to 55, or 45 to 50, % by weight based on a total weight of all non-resin and non-composition components of the base layer 14. In additional non-limiting embodiments, all values and ranges of values of base fiber amounts within and including the aforementioned range endpoints are hereby expressly contemplated.

It should be appreciated that “% by weight based on a total weight of all non-resin and non-composition components” as referred to throughout this specification is a percentage calculated without consideration of the weight of resin 16 and composition 22 added to the particular layer 12, 14 or the friction material 10. For example, the % by weight base fibers 42 present in the base layer 14 would be calculated by dividing the total weight of base fibers 42 present in the base layer 14 by the total weight of the base fibers 42, filler 44, and any additives present in the base layer 14, multiplied by 100. The weight of the resin 16 and the composition 22 in the base layer 14 would not be considered in the calculation. The details of the resin 16 and the composition 22 are described below.

The base fibers 42 are not limited in type and may be chosen from aramid fibers, carbon fibers, cellulose fibers, acrylic fibers, polyvinyl alcohol fibers, glass fibers, mineral fibers, and combinations thereof. In various embodiments, the base fibers 42 are one of or combinations of the aforementioned base fiber types. For example, in some embodiments, the base fibers 42 are aramid fibers and cellulose fibers. All weight ranges and ratios of the various combinations of the aforementioned base fiber types are hereby expressly contemplated in various non-limiting embodiments.

In various embodiments, the base fibers 42 include aramid. As a non-limiting example, in some embodiments, the friction material includes from about 5 to about 35, % by weight aramid fibers based the total weight of the base fibers 42 included in the friction material. In other embodiments, the base fibers 42 consist of or consist essentially of aramid. Various non-limiting examples of aramids include tradenames such as KEVLAR®, TWARON®, NOMEX®, NEW STAR® and TEIJINCONEX®. One or more types of aramids may be used. In one embodiment, the aramid is poly-paraphenylene terephthalamide. In another embodiment, the aramid is two or more types of aramids, e.g. a first poly-paraphenylene terephthalamide and a second poly-paraphenylene terephthalamide that is different from the first. In various preferred embodiments, aramid fibers of the tradename TWARON® or KEVLAR® may be used. Of course, in other embodiments, aramid fibers of other tradenames may be used.

In some embodiments, the base fibers 42 include cellulose, e.g. from wood, cotton, etc. In other embodiments, the base fibers 42 consist essentially of or consist of cellulose. The cellulose fibers may be chosen from abacá fiber, bagasse fiber, bamboo fiber, birch fiber, coir fiber, cotton fiber, fique fiber, flax fiber, linen fiber, hemp fiber, jute fiber, kapok fiber, kenaf fiber, piña fiber, pine fiber, raffia fiber, ramie fiber, rattan fiber, sisal fiber, wood fiber, and combinations thereof. In some specific embodiments, cellulose fibers that are derived from wood are used, such as birch fibers, pine fibers, and/or eucalyptus fibers. In other embodiments, cellulose fibers such as cotton fibers are used. If used, cotton fibers typically have fibrillated strands attached to a main fiber core and aid in preventing delamination of the friction material 10 during use.

In still other embodiments, the base fibers 42 include acrylic. Acrylic is formed from one or more synthetic acrylic polymers such as those formed from at least 85% by weight acrylonitrile monomers. In other embodiments, the base fibers 42 consist essentially of or consist of acrylic.

In various embodiments, the base fibers 42 have diameters from 1 μm to 500 μm and lengths from 0.1 mm to 20 mm. In additional non-limiting embodiments, all values and ranges of values of diameter within and including the aforementioned range endpoints are hereby expressly contemplated. The base fibers 42 may be woven, non-woven, or any other suitable construction.

In various embodiments, the base fibers 42 have a Canadian Standard Freeness (CSF) of greater than 40 or 50. In some embodiments, the base fibers 42 have a CSF of from 40 to 250 or from 40 to 125. In other embodiments, less fibrillated base fibers 42 are utilized which have a CSF of 250 to 750. In still other embodiments, the base fibers 42 have a CSF of 300 to 750 or greater than 750. In additional non-limiting embodiments, all values and ranges of values of CSF within and including the aforementioned range endpoints are hereby expressly contemplated.

The terminology “Canadian Standard Freeness” (“CSF”) is the degree of fibrillation of fibers and may be described as the measurement of freeness of the fibers. CSF is tested via the Technical Association of the Pulp and Paper Industry (“TAPPI”) test procedure T227 om-85. The CSF test procedure is an empirical procedure which gives an arbitrary measure of the rate at which a suspension of three grams of fiber in one liter of water may be drained. Therefore, less fibrillated fibers have higher freeness or higher rate of drainage of fluid from the friction material 10 than other fibers or pulp. Notably, CSF values can be converted to Schopper Riegler values. CSF can be an average value representing the CSF of all base fibers 42 in the base layer 14. As such, it is to be appreciated that the CSF of any one particular base fiber 42 may fall outside the ranges provided above, yet the average value will fall within these ranges.

In addition, the base layer 14 may also include a filler 44. If included, the filler 44 can be present in an amount of up to 80 or from 20 to 80, % by weight based on a total weight of all non-resin and non-composition components of the base layer 14. In various embodiments, the filler 44 is present in an amount of from 25 to 75, 30 to 70, 35 to 65, 40 to 60, 45 to 55, or 45 to 50, % by weight based on a total weight of the base layer 14. In additional non-limiting embodiments, all values and ranges of values of filler amounts within and including the aforementioned range endpoints are hereby expressly contemplated.

The filler 44 is not particularly limited and may be any known in the art. For example, the filler 44 may be a reinforcing filler or a non-reinforcing filler. The filler 44 may be chosen from cashew nut particles, silica, diatomaceous earth, graphite, carbon, alumina, magnesia, calcium oxide, titania, ceria, zirconia, cordierite, mullite, sillimanite, spodumene, petalite, zircon, silicon carbide, titanium carbide, boron carbide, hafnium carbide, silicon nitride, titanium nitride, titanium boride, and combinations thereof. In various embodiments, the filler 44 includes one of or combinations of the aforementioned filler 44 types. For example, in various embodiments, the filler 44 is carbon particles and/or diatomaceous earth particles. All weight ranges and ratios of the various combinations of the aforementioned filler 44 types are hereby expressly contemplated in various non-limiting embodiments.

The filler 44 may have a particle size from 0.5 μm to 250 μm, from 10 μm to 200 μm, 10 μm to 160 μm, 20 μm to 160 μm, or from 40 μm to 160 μm. In additional non-limiting embodiments, all values and ranges of values of particle size within and including the aforementioned range endpoints are hereby expressly contemplated.

In some embodiments, the base layer 14 includes base fibers 42 selected from cellulose fibers, aramid fibers and carbon fibers and filler 44 selected from diatomaceous earth particles and carbon particles.

In other embodiments, the base layer 14 consists essentially of base fibers 42 (and the resin 16 and composition 22) or consists of base fibers 42 (and the resin 16 and composition 22). To this end, the base layer 14 can be substantially free of filler 44, or free of filler 44.

The base layer 14 may further include additives known in the art.

### The Friction-Generating Layer

As shown in FIGS. 1 and 2, the friction material 10 includes the friction-generating layer 12. The friction-generating layer 12 may also be referred to as a “deposit”. In some embodiments, the friction-generating layer 12 may be disposed on the base layer 14 and included in the friction material 10 as a distinct and well-defined layer or deposit. In other embodiments, the friction-generating layer 12 may be on the base layer 14 and disposed in the friction material 10 in a graduated pattern measured in a direction from the friction-generating surface 18 into the base layer 14 (towards the bonding surface 20) wherein a concentration of the components of the friction-generating layer 12 is greatest at the friction-generating surface 18.

In many embodiments, the friction-generating layer 12 has a thickness T₂ of from 10 μm to 600 μm, from 12 μm to 450 μm, from 12 μm to 300 μm, from 12 μm to 150 μm, or from 14 μm to 100 μm. Alternatively, the thickness T₂ of the friction-generating layer 12 is less than 150 μm, less than 150 μm, less than 125 μm, less than 100 μm, or less than 75 μm, but greater than 10 μm. In additional non-limiting embodiments, all values and ranges of values of thickness T₂ within and including the aforementioned range endpoints are hereby expressly contemplated. The thickness T₂ may refer to a thickness of the friction-generating layer 12 prior to, or after, resin 16 cure.

The friction-generating layer 12 includes friction-adjusting particles 32. The friction-adjusting particles 32 may include one or more different types of particles. The friction-adjusting particles 32 provide a high coefficient of friction to the friction material 10. The type or types of the friction-adjusting particles 32 utilized may vary depending on the friction characteristics sought.

In various embodiments, the friction-adjusting particles 32 are chosen from any of the one or more filler particle types (the filler 44) described above. The friction-generating layer 12 may consist essentially of or consist of the friction-adjusting particles 32 (and the resin 16 and/or the composition 22).

In various embodiments, the friction-adjusting particles 32 are chosen from silica particles, carbon particles, graphite particles, alumina particles, magnesia particles, calcium oxide particles, titania particles, ceria particles, zirconia particles, cordierite particles, mullite particles, sillimanite particles, spodumene particles, petalite particles, zircon particles, silicon carbide particles, titanium carbide particles, boron carbide particles, hafnium carbide particles, silicon nitride particles, titanium nitride particles, titanium boride particles, cashew nut particles, rubber particles, and combinations thereof.

In some embodiments, the friction-adjusting particles 32 are selected from carbon particles, diatomaceous earth particles, cashew nut particles, and combinations thereof.

In various embodiments, the friction-adjusting particles 32 have an average diameter of from 100 nm to 80 μm, from 500 nm to 30 μm, or from 800 nm to 20 μm. In additional non-limiting embodiments, all values and ranges of values of average diameter within and including the aforementioned range endpoints are hereby expressly contemplated.

In some embodiments, the friction-adjusting particles 32 include cashew nut particles. In yet other particular embodiments, the friction-adjusting particles 32 consist essentially of or consist of cashew nut particles or particles derived from cashew nut shell oil. Of course, in some such embodiments, the friction-generating layer 12 consists essentially of or consists of cashew nut particles (and the resin 16 and composition 22). Those of skill in the art understand cashew nut particles to be particles formed from cashew nut shell oil. Cashew nut shell oil is sometimes also referred to as cashew nut shell liquid (CNSL) and its derivatives.

In some embodiments, the friction-adjusting particles 32 include diatomaceous earth particles. Of course, in other embodiments, the friction-adjusting particles 32 consist essentially of or consist of diatomaceous earth particles. Of course, in some such embodiments, the friction-generating layer 12 consists essentially of or consists of diatomaceous earth particles (and the resin 16 and composition 22). Diatomaceous earth is a mineral comprising silica. Diatomaceous earth is an inexpensive, abrasive material that exhibits a relatively high coefficient of friction. CELITE® and CELATOM® are two trade names of diatomaceous earth that may be used.

In some embodiments, the friction-adjusting particles 32 include a combination of cashew nut particles and diatomaceous earth particles. Of course, in other embodiments, the friction-adjusting particles 32 consist essentially of or consist of a combination of cashew nut particles and diatomaceous earth particles. In some such embodiments, the friction-generating layer 12 consists essentially of or consists of a combination of cashew nut particles and diatomaceous earth particles (and the resin 16 and/or the composition 22).

In various embodiments, the friction-adjusting particles 32 include elastomeric particles. Elastomeric particles exhibit elasticity and other rubber-like properties. Such elastomeric particles may be at least one particle type chosen from cashew nut particles and rubber particles. In some embodiments, rubber particles including silicone rubber, styrene butadiene rubber, butyl rubber, and halogenated rubbers such as chlorobutyl rubber, bromobutyl rubber, polychloroprene rubber, and nitrile rubber are used. In other embodiments, rubber particles consisting essentially of or consisting of silicone rubber, styrene butadiene rubber, butyl rubber, and halogenated rubbers such as chlorobutyl rubber, bromobutyl rubber, polychloroprene rubber, and nitrile rubber are used.

In some particular embodiments, the elastomeric particles include silicone rubber particles. In other particular embodiments, the elastomeric particles consist essentially of or consist of silicone rubber particles.

In some particular embodiments, the elastomeric particles include nitrile rubber particles. In other particular embodiments, the elastomeric particles consist essentially of or consist of nitrile rubber particles.

The friction-generating layer 12 may further include friction-adjusting fibers (not shown in the Figures). The friction-adjusting fibers may include different fiber types. In various embodiments, the friction-adjusting fibers are chosen from any of the one or more of the base fiber types (base fibers 42) described above. Alternatively, the base fibers 42 may be chosen from any one or more of the friction-adjusting fibers described below.

If included, the friction-adjusting fibers are not particularly limited in type and may be chosen from aramid fibers, carbon fibers, cellulose fibers, acrylic fibers, polyvinyl alcohol fibers,

glass fibers, mineral fibers, and combinations thereof. In various embodiments, the friction-adjusting fibers include one of or a combination of the aforementioned friction-adjusting fiber types. For example, in some embodiments, the friction-adjusting fibers are cellulose fibers. As another example, in some embodiments, the friction-adjusting fibers are carbon fibers. As yet another example, in some embodiments, the friction-adjusting fibers are aramid fibers. Of course, in other examples, the friction-adjusting fibers are a combination of fiber types, e.g. are cellulose and carbon, are aramid and cellulose, etc. All weight ranges and ratios of the various combinations of the aforementioned friction-adjusting fiber types are hereby expressly contemplated in various non-limiting embodiments.

In some embodiments, the friction-generating layer 12 includes friction-adjusting particles 32 but does not include the friction-adjusting fibers. Of course, in some such embodiments, the friction-generating layer 12 consists essentially of or consists of friction-adjusting particles 32 (in addition to the resin 16 and/or the composition 22).

In other embodiments, the friction-generating layer 12 includes both the friction-adjusting particles 32 and the friction-adjusting fibers. For example, in some particular embodiments, the friction-generating layer 12 includes cellulose fibers, diatomaceous earth particles, and, optionally, elastomeric particles. In other particular embodiments, the friction-generating layer 12 includes cellulose fibers, diatomaceous earth particles, and cashew nut particles.

The friction-generating layer 12 may further include additives known in the art.

In various embodiments, the components (e.g. the friction-adjusting particles 32, friction-adjusting fibers, and/or any additives) of the friction-generating layer 12 or friction-generating deposit are utilized in an amount of from 0.5 to 100 lbs. per 3000 ft² (0.2 to 45.4 kg per 278.71 m²) of a surface of the base layer 14, from 3 to 80 lbs. per 3000 f^{t2} (1.4 kg to 36.3 kg per 278.71 m²) of the surface of the base layer 14, from 3 to 60 lbs. per 3000 f^{t2} (1.4 kg to 27.2 kg per 278.71 m²) of the surface of the base layer 14, from 3 to 40 lbs. per 3000 f^{t2} (1.4 kg to 18.1 kg per 278.71 m²) of the surface of the base layer 14, from 3 to 20 lbs. per 3000 f^{t2} (1.4 kg to 9.1 kg per 278.71 m²) of the surface of the base layer 14, from 3 to 12 lbs. per 3000 f^{t2} (1.4 kg to 5.4 kg per 278.71 m²) of the surface of the base layer 14, or from 3 to 9 lbs. per 3000 f^{t2} (1.4 kg to 4.1 kg per 278.71 m²) of the surface of the base layer 14. In additional non-limiting embodiments, all values and ranges of values of amounts within and including the aforementioned range endpoints are hereby expressly contemplated. The amounts described immediately above are in units of lbs. per 3000 ft², which are units customarily used in the paper making industry as a measurement of weight based on a surface area. Above, the units express the weight of the friction-generating layer 12 for every 3000 ft² of the surface of the base layer 14.

It should be appreciated that the terminology “consists essentially of” as used throughout this disclosure describes embodiments that include a designated component (e.g. cellulose fibers) or components of a particular component class (e.g. base fibers 42) and less than 5, 4, 3, 2, 1, 0.5, 0.1, 0.05, or 0.01% by weight of all other like components (e.g. additional aramid fibers) of the particular component class, based on the total weight of the particular component class included in the friction material 10.

As a non-limiting example, the terminology “base fibers 42 that consist essentially of cotton fiber”, as described above, describes base fibers 42 that include cotton fiber and less than 5, 4, 3, 2, 1, 0.5, 0.1, 0.05, or 0.01% by weight other base fibers 42, based on a total weight of the base fibers 52 included in the base layer 14 of the friction material 10.

It should also be appreciated that the terminology “consists essentially of” as used throughout this disclosure describes embodiments that include a designated component (e.g. cellulose fibers) or components in a particular layer (e.g. the friction-generating layer 12) and less than 5, 4, 3, 2, 1, 0.5, 0.1, 0.05, or 0.01, % by weight of other components (e.g. additional fibers, particles, additives, etc.) in the particular layer, based on a total weight of all components in the layer (excluding the resin 16 and the composition 22 in the particular layer).

As a non-limiting example, the terminology “the friction-generating layer 12 that consists essentially of cashew nut particles”, as described above, describes the friction-generating layer 12 that includes cashew nut particles and less than 5, 4, 3, 2, 1, 0.5, .1, 0.05, or 0.01% by weight of all other components included in the friction-generating layer 12, based on a total weight of all components in in the friction-generating layer 12 (excluding any of the resin 16 and the composition 22 in the friction-generating layer 12).

As a further non-limiting example, the terminology “the base layer 14 that consists essentially of cotton fiber”, as described above, describes the base layer 14 that includes cotton fiber and less than 5, 4, 3, 2, 1, 0.5, 0.1, 0.05, or 0.01% by weight of all other components included in the base layer 14, based on a total weight of all components in the base layer 14 (excluding any of the resin 16 and the composition 22 in the friction-generating layer 12). The Resin:

As shown in FIGS. 1 and 2, the resin 16 is present in the friction material 10. The resin 16 may be dispersed homogeneously or heterogeneously within the friction material 10. For example, the resin 16 may be dispersed in at least one of the base layer 14 and the friction-generating layer 12. As yet another example, at least one of the base layer 14 and the friction-generating layer 12 may include one or more different types of the resin 16. In various embodiments, the resin 16 is dispersed homogeneously or heterogeneously throughout the base layer 14 and may partially or wholly encapsulate the friction-generating layer 12. In the Figures, the numeral 16 refers to uncured resin whereas the numeral 17 refers to cured resin.

The resin 16 may be any known in the art and may be curable. Alternatively, the resin 16 may be of the type that does not cure. In various embodiments, depending on the stage of formation of the friction material 10, the resin 16, 17 may be uncured, partially cured, or entirely cured.

In some embodiments, the resin 16 may be any thermosetting resin suitable for providing structural strength to the friction material 10. Various resins 16 that may be utilized include phenolic resins and phenolic-based resins. A phenolic resin is a class of thermosetting resins that is produced by the condensation of an aromatic alcohol, typically a phenol, and an aldehyde, typically a formaldehyde. A phenolic-based resin is a thermosetting resin blend that typically includes at least 50% by weight of a phenolic resin based on the total weight of all resins and excluding any solvents or processing acids. It is to be understood that various phenolic-based resins may include modifying ingredients, such as epoxy, butadiene, silicone, tung oil, benzene, cashew nut oil and the like. In some embodiments, a silicone modified phenolic resin which includes 5 to 80% by weight of a silicone resin with the remainder % by weight being attributed to a phenolic resin or combination of phenolic and other different resins is used. In other embodiments, an epoxy modified phenolic resin which includes 5 to 80% by weight of an epoxy resin with the remainder % by weight being attributed to a phenolic resin or combination of phenolic and other different resins is used.

In one or more embodiments, the resin 16 may include, for example, 5 to 100 or 5 to 80, % by weight of a silicone resin based on the total weight of all resins and excluding any solvents or processing acids. Silicone resins that may be used may include thermal curing silicone sealants and silicone rubbers. Various silicone resins may also be used such as those that include D, T, M, and Q units (e.g. DT resins, MQ resins, MDT resins, MTQ resins, QDT resins . . . ).

In various embodiments, the resin 16 is present in an amount of from 20 to 90, 20 to 80, or 25 to 60, % by weight based on a total weight of all non-resin and non-composition components in the friction material 10. For example, the resin 16 may be present in an amount of from 25 to 75, 25 to 70, 30 to 75, 30 to 70, or 30 to 55, or 35 to 65, % by weight based on a total weight of all non-resin and non-composition components in the friction material 10. This value may be alternatively described as resin “pick up.” In additional non-limiting embodiments, all values and ranges of values of resin amounts within and including the aforementioned range endpoints are hereby expressly contemplated.

Once cured, the cured resin 17 confers strength and rigidity to the friction material 10 and adheres the components of the layers 12, 14 to one another while maintaining a desired porosity for proper lubricant flow and retention, and also bonds the friction material 10 to the substrate 62, as described below.

### The Composition

As shown in FIGS. 1 and 2, the composition 22 is present in the friction material 10. The composition 22 may be dispersed homogeneously or heterogeneously within the friction material 10. The composition 22 is present in at least one of the base layer 14 and the friction-generating layer 12. In other words, the composition 22 may be present in only the friction-generating layer 12, only the base layer 14, or both the friction-generating layer 12 and the base layer 14. In various embodiments, the composition 22 is dispersed homogeneously or heterogeneously throughout the base layer 14 and may partially or wholly encapsulate the friction-generating layer 12. In other embodiments, the composition 22 is dispersed homogeneously or heterogeneously throughout the friction-generating layer 12 and may partially or wholly penetrate into base layer 14. In the Figures, the numeral 22 refers to uncured composition whereas the numeral 23 refers to cured composition.

The composition 22 includes a plurality of triglycerides. A triglyceride is an ester derived from glycerol and three fatty acids. The plurality of triglycerides may include different types triglycerides. That is, in various embodiments, each triglyceride of the plurality of triglycerides can include any combination of one or more of the fatty acids described below.

The plurality of triglycerides in the composition 22 comprises polyunsaturated fatty acid in a content of greater than 60, greater than 65, from 60 to 90, or from 65 to 85, % by weight based on a total weight of the plurality of triglycerides included in the composition 22. Because the composition 22 includes the plurality of triglycerides having a high content of di- and tri-unsaturated esters (i.e., polyunsaturated fatty acid content in an amount of greater than 60, or greater than 65, % by weight), the plurality of triglycerides polymerize upon exposure to oxygen in air. This polymerization, which can also be referred to as “drying” or hardening, produces a reaction product that is rigid but flexible. The polymerization reaction of the plurality of triglycerides is exothermic.

The plurality of triglycerides typically comprises at least one fatty acid selected from palmitic acid, stearic acid, arachidic acid, palmitoleic acid, oleic acid, eicosenoic acid, linoleic acid, and alpha(α)-linolenic acid. In some embodiments, the plurality of triglycerides comprises alpha(α)-linolenic acid in an amount of greater than 40, greater than 45, greater than 50, greater than 55, or greater than 60, % by weight based on a total weight of the plurality of triglycerides included in the composition 22. Further, in some such embodiments, the plurality of triglycerides comprises linoleic acid in an amount of greater than 12, greater than 14, greater than 25, greater than 40, or greater than 50% by weight based on a total weight of the plurality of triglycerides included in the composition 22. Furthermore, in some such embodiments, the plurality of triglycerides comprises oleic acid in an amount of greater than 10% by weight based on a total weight of the plurality of triglycerides included in the composition.

In some embodiments, the plurality of triglycerides comprises alpha(α)-eleostearic acid. However, the plurality of triglycerides typically comprises less than 20, less than 10, or less than 1% α-eleostearic acid. In some embodiments, the plurality of triglycerides is substantial free of α-eleostearic acid.

In some embodiments, the composition 22 includes the plurality of triglycerides which are synthetic. That is, the plurality of triglycerides is produced from chemical feedstocks, e.g. is based on petroleum and other feedstocks.

In other embodiments, the composition 22 includes the plurality of triglycerides which are harvested from or derived from plant-based or renewable resources, e.g. the composition is a natural oil. For example, the composition 22 may be a natural oil selected from linseed oil, grapeseed oil, sunflower, and hemp seed oil. In other words, the composition 22 may consist of, or consist essentially of, a natural oil selected from linseed oil, grapeseed oil, sunflower, and hemp seed oil.

In various embodiments, the composition 22 is present in an amount of from 1 to 45, 2 to 35, or 3 to 25, % by weight based on a total weight of all non-resin and non-composition components in the friction material 10. For example, the composition 22 may be present in an amount of from 25 to 75, 25 to 70, 30 to 75, 30 to 70, or 30 to 55, or 35 to 65, % by weight based on a total weight of all non-resin and non-composition components in the friction material 10. This value may be alternatively described as composition 22 “pick up.” In additional non-limiting embodiments, all values and ranges of values of composition 22 amounts within and including the aforementioned range endpoints are hereby expressly contemplated.

In some embodiments, the resin 16 and the composition 22 are respectively present in a ratio, by weight, of from 20:1 to 2:1, or from 10:1 to 2:1. In many such embodiments, the resin 16 is a phenolic resins or phenolic-based resin.

### The Physical Properties of the Friction Material

The friction material 10 includes a plurality of pores (not shown in the Figures). Each of the pores has a pore size.

The pores may he dispersed homogeneously or heterogeneously throughout the friction material 10. For example, at least one of the base, layer 14 and the friction-generating layer 12 may include the pores (be porous). In some examples, the base layer 14 and the friction-generating layer 12 have a different porosity, average pore size, and/or median pore size. For example, in some embodiments, friction-generating layer 12 has a lower porosity than the base layer 14 as determined using ASTM test method D4404-10. In other examples, the base layer 14 and the friction-generating layer 12 have about the same porosity, average pore size, and/or median pore size.

The median pore size may be determined using American Society for Testing and Materials (“ASTM”) test method D4404-10. In various embodiments, the median pore size in the friction material 10 is, from 0.5 to 50, 1 to 50, 2 to 50, 2 to 45, 2 to 30, 2 to 15, or 3 to 10, μm as determined using ASTM test method D4404-10. In additional non-limiting embodiments, all values and ranges of values of median pore size within and including the aforementioned range endpoints are hereby expressly contemplated.

In other embodiments, the friction material 10 has a porosity of from 5 to 90 or 25 to 85, % as determined using ASTM test method D4404-10. The porosity of the friction material 10 may be described as a percentage of the friction material 10 that is open to air. Alternatively, the porosity may be described as the percentage of the friction material 10, based on volume, that is air or not solid. In various embodiments, the friction material 10 has a porosity of from 30 to 80, or 40 to 75, % as determined using ASTM test method D4404-10. In additional non-limiting embodiments, all values and ranges of values of porosity within and including the aforementioned range endpoints are hereby expressly contemplated. In some embodiments, the friction-generating layer 12 has a lower porosity than the base layer 14 as determined using ASTM test method D4404-10. In some embodiments, the base layer 14 has a lower porosity than the base layer 14 as determined using ASTM test method D4404-10. The more porous the friction material 10, the more efficiently heat is dissipated. The oil flow in and out of the friction material 10 during engagement of the friction material 10 during use occurs more rapidly when the friction material 10 is porous. For example, when the friction material 10 has a higher mean flow pore diameter and porosity, the friction material 10 is more likely to run cooler or with less heat generated in a transmission due to better automatic transmission fluid flow throughout the pores of the friction material 10. During operation of a transmission, oil deposits on the friction material 10 tend to develop over time due to a breakdown of automatic transmission fluid, especially at high temperatures. The oil deposits tend to decrease the size of the pores. Therefore, when the friction material 10 is formed with larger pores, the greater the remaining/resultant pore size after oil deposit. Porosity of the friction material 10 may be further modified based on choice of the fibers (34, 42), the particles, (32, 44), the resin 16, the composition 22, the composition of the layers (12, 14), and a raw paper weight.

In various embodiments, the friction material 10 has high porosity such that there is a high fluid permeation capacity during use. In such embodiments, it may be important that the friction material 10 not only be porous, but also be compressible. For example, the fluids permeated into the friction material 10 typically must be capable of being squeezed or released from the friction material 10 quickly under the pressures applied during operation of the transmission, yet the friction material 10 typically must not collapse. It may also be important that the friction material 10 have high thermal conductivity to also help rapidly dissipate the heat generated during operation of the transmission.

The initial thickness T₁ of the friction material 10, is typically from 0.3 to 4, from 0.4 to 3, from 0.4 to 2, from 0.4 to 1.6, from 0.4 to 1.5, from 0.5 to 1.4, from 0.6 to 1.3, from 0.7 to 1.2, from 0.8 to 1.1, or from 0.9 to 1, mm. This thickness T₁ refers to a thickness prior to bonding to the substrate 62 and may be referred to as caliper thickness. This thickness T₁ can refer to the thickness of the friction material 10 with uncured resin present, or the thickness of the raw paper without resin 16. In additional non-limiting embodiments, all values and ranges of values of thickness T₁ within and including the aforementioned range endpoints are hereby expressly contemplated.

After bonding to the substrate 62 and resin 17 cure, a total thickness T₄ of the friction material 10 is typically from 0.3 to 4, from 0.3 to 3.75, from 0.4 to 3, from 0.3 to 2, from 0.3 to 1.6, from 0.3 to 1.5, from 0.3 to 1.4, from 0.35 to 1.3, from 0.7 to 1.2, from 0.8 to 1.1, or from 0.9 to 1, mm. This thickness T₄ is typically measured after bonding to the substrate 62. In additional non-limiting embodiments, all values and ranges of values of total thickness T₄ within and including the aforementioned range endpoints are hereby expressly contemplated.

In still other embodiments, the friction material 10 has a compression of from 2 to 30, from 4 to 15, or from 6 to 8, %, at 2 MPa. Compression is a material property of the friction material 10 that may be measured when the friction material 10 is disposed on the substrate 62 (i.e., measured when part of a friction plate 60, described below) or when the friction material 10 is not disposed on the substrate 62. Typically, compression is a measurement of a distance (e.g. mm) that the friction material 10 is compressed under a certain load. For example, a thickness of the friction material 10 before a load is applied is measured. Then, the load is applied to the friction material 10. After the load is applied for a designated period of time, the new thickness of the friction material 10 is measured. Notably, this new thickness of the friction material 10 is measured as the friction material 10 is still under the load. The compression is typically related to elasticity, as would be understood by those of skill in the art. The more elastic the friction material 10 is, the more return that will be observed after compression. This typically leads to less lining loss and formation of less hot spots, both of which are desirable. In additional non-limiting embodiments, all values and ranges of compression values within and including the aforementioned range endpoints are hereby expressly contemplated.

In various embodiments, the friction material 10 is bonded to the substrate 62, which is typically metal. Several examples of the substrate 62 include, but are not limited to, a clutch plate, a synchronizer ring, and a transmission band. The friction material 10 includes the friction-generating surface 18 and an oppositely facing bonding surface 20. The friction-generating surface 18 experiences select interfacial frictional engagement with the opposed, rotating surface in the presence of a lubricant. The bonding surface 20 possess promotes adhesion to the substrate 62 and reduces the build-up of heat when the friction material 10 is in use.

When bonded to the substrate 62, the bonding surface 20 achieves bonded attachment to the substrate 62 with or without the aid of an adhesive or some other suitable bonding technique. In one exemplary embodiment, which is described below, the friction material 10 is used in the friction plate 60 with the bonding surface 20 promoting a robust bond between the friction material 10 and the substrate 62.

The lubricant may be any suitable lubricating fluid such as an automatic transmission fluid. The flow rate of the lubricant over the friction material 10 may be managed to allow the temperature at the friction-generating surface 18 and or the bonding surface 20 to exceed 350° C. for extended periods in an effort to improve fuel efficiency. In various embodiments, while the friction material 10 performs satisfactorily above 350° C., and up to 500° C., it is not limited only to such high-temperature environments and may, if desired, be used in a wet clutch designed to maintain a temperature at the friction-generating surface 18 below 350° C. In additional non-limiting embodiments, all values and ranges of values of operating temperatures within and including the aforementioned range endpoints are hereby expressly contemplated.

### Friction Plate

As shown in FIG. 2, this disclosure also provides the friction plate 60 that includes the friction material 10 and the substrate 62 (e.g. a metal plate), as first introduced above. The substrate 62 has at least two surfaces 64, 66, and the friction material 10 is typically bonded to one or both of these surfaces 64, 66. The bonding or adherence of the friction material 10 to one or both surfaces 64, 66 may be achieved by any adhesive or means known in the art, e.g. a phenolic resin or any resin 16, 17 described above.

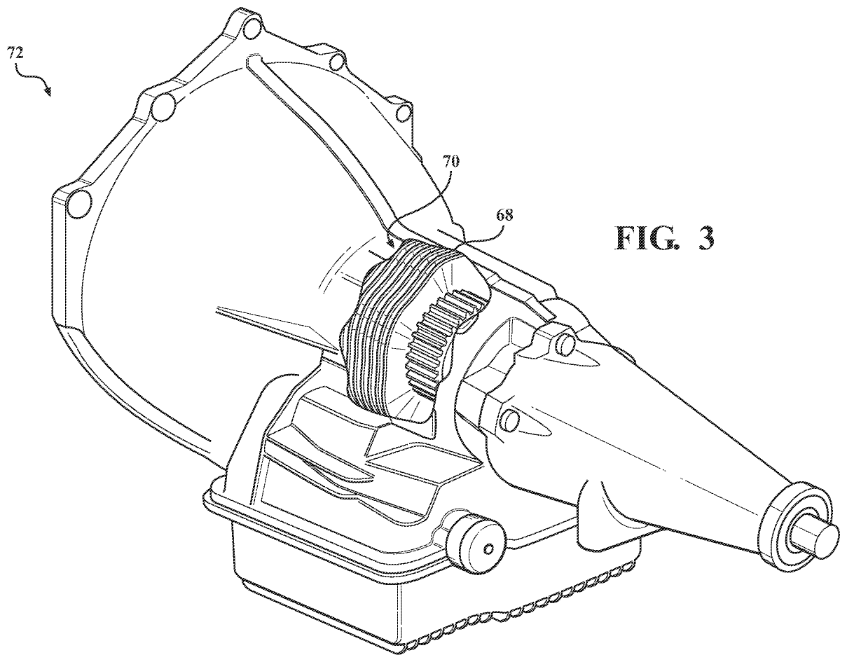

Referring now to FIG. 3, the friction plate 60 may be used, sold, or provided with a separator plate 68 to form a clutch pack or clutch assembly 70. This disclosure also provides the friction plate 60 itself including the friction material 10 and the substrate 62 and a wet clutch assembly 70 including the friction plate 60 and the separator plate 68.

Still referring to FIG. 3, this disclosure also provides a transmission 72 that includes the wet clutch assembly 70. The transmission 72 may be an automatic transmission or a manual transmission.

All combinations of the aforementioned embodiments throughout the entire disclosure are hereby expressly contemplated in one or more non-limiting embodiments even if such a disclosure is not described verbatim in a single paragraph or section above. In other words, an expressly contemplated embodiment may include any one or more elements described above selected and combined from any portion of the disclosure.

One or more of the values described above may vary by ±5%, ±10%, ±15%, ±20%, ±25%, etc. so long as the variance remains within the scope of the disclosure. Unexpected results may be obtained from each member of a Markush group independent from all other members. Each member may be relied upon individually and or in combination and provides adequate support for specific embodiments within the scope of the appended claims. The subject matter of all combinations of independent and dependent claims, both singly and multiply dependent, is herein expressly contemplated. The disclosure is illustrative including words of description rather than of limitation. Many modifications and variations of the present disclosure are possible in light of the above teachings, and the disclosure may be practiced otherwise than as specifically described herein.

It is also to be understood that any ranges and subranges relied upon in describing various embodiments of the present disclosure independently and collectively fall within the scope of the appended claims and are understood to describe and contemplate all ranges including whole and/or fractional values therein, even if such values are not expressly written herein. One of skill in the art readily recognizes that the enumerated ranges and subranges sufficiently describe and enable various embodiments of the present disclosure, and such ranges and subranges may be further delineated into relevant halves, thirds, quarters, fifths, and so on. As just one example, a range “of from 0.1 to 0.9” may be further delineated into a lower third, i.e. from 0.1 to 0.3, a middle third, i.e. from 0.4 to 0.6, and an upper third, i.e. from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

What is claimed is:

1. A friction material comprising:
(A) a base layer comprising base fibers and presenting a bonding surface;
(B) a friction-generating layer comprising friction-adjusting particles deposited on said base layer and presenting a friction-generating surface facing opposite said bonding surface of said base layer;
(C) a curable resin present in said friction-generating layer and said base layer; and
(D) a composition comprising a plurality of triglycerides, said plurality of triglycerides comprising polyunsaturated fatty acid in a content of from 60 to 90% by weight based on a total weight of said plurality of triglycerides included in said composition;
wherein said composition is present in at least one of said friction-generating layer and said base layer.

2. The friction material as set forth in claim 1 wherein said plurality of triglycerides comprises at least one fatty acid selected from palmitic acid, stearic acid, arachidic acid, palmitoleic acid, oleic acid, eicosenoic acid, linoleic acid, and α-linolenic acid.

3. The friction material as set forth in claim 1 wherein said plurality of triglycerides comprises α-linolenic. acid in an amount of greater than 40% by weight based on a total weight of said plurality of triglycerides included in said composition.

4. The friction material as set forth in claim 1 wherein said plurality of triglycerides comprises linoleic acid in an amount of greater than 12% by weight based on a total weight of said plurality of triglycerides included in said composition

5. The friction material as set forth in claim 1 wherein said plurality of triglycerides comprises oleic acid in an amount of greater than 10% by weight based on a total weight of said plurality of triglycerides included in said composition.

6. The friction material as set forth in claim 1 wherein said composition is a natural oil selected from linseed oil, grapeseed oil, sunflower, and hemp seed oil.

7. The friction material as set forth in claim 1 wherein said friction-adjusting particles are selected from carbon particles, diatomaceous earth particles, cashew nut particles, and combinations thereof.

8. The friction material as set forth in claim 1 wherein said friction-adjusting particles have an average diameter of from 100 nm to 80 μm.

9. The friction material as set forth in claim 1 wherein said friction-generating layer further comprises cellulose fibers.

10. The friction material as set forth in claim 1 wherein said base fibers comprise aramid fibers and cellulose fibers.

11. The friction material as set forth in claim 1 wherein said base layer further comprises cashew nut particles, carbon particles, and/or diatomaceous earth particles.

12. The friction material as set forth in claim 1 wherein said friction-generating layer has a lower porosity than said base layer as determined using ASTM test method D4404-10.

13. The friction material as set forth in claim 1 wherein said friction-generating layer has a thickness of from 10 to 600 μm and said base layer has a thickness from 0.2 mm to 3.75 mm.

14. The friction material as set forth in claim 1 wherein said composition is present in said friction-generating layer and said base layer.

15. The friction material as set forth in claim 1 wherein said composition is present in an amount of from 1 to 45% by weight based on a total weight of all non-resin and non-composition components in said friction material, and wherein said resin is present in an amount of from 20 to 90% by weight based on a total weight of all non-resin and non-composition components in said friction material.

16. The friction material as set forth in claim 1 wherein said resin and said composition are respectively present in a weight ratio of from 20:1 to 2:1.

17. The friction material as set forth in claim 1 wherein;
said plurality of triglycerides comprises at least one fatty acid selected from palmitic acid, stearic acid, arachidic acid, palmitoleic acid, oleic acid, eicosenoic acid, linoleic acid, and α-linolenic acid; and
said composition is a natural oil selected from linseed oil, grapeseed oil, sunflower, and hemp seed oil; and
said friction-adjusting particles have an average diameter of from 100 nm to 80 μm and are selected from carbon particles, diatomaceous earth particles, cashew nut particles, and combinations thereof.

18. A friction plate comprising a substrate and said friction material as set forth in claim 1, which is cured and bonded to said substrate.

19. A wet clutch assembly comprising said friction plate of claim 18 and a separator plate.

20. A transmission comprising said wet clutch assembly of claim 19.
